(19) United States
(12) Patent Application Publication
(10) Pub. No.: US 2026/0359667 A1
(43) Pub. Date: Nov. 12, 2026

(54) GENERATION OF FURNITURE ASSEMBLY INSTRUCTIONS

(71) Applicant: Inter IKEA Systems B.V., DELFT (NL)

(72) Inventors: Martin ENTHED, Steninge (SE); Antonia PEHRSON, Malmö (SE); Anders LUNDGREN, Halmstad (SE); Daniela HERTEL, Malmö (SE); Niklas JOHANSSON, Malmö (SE)

(73) Assignee: Inter IKEA Systems B.V., DELFT (NL)

(21) Appl. No.: 19/142,182

(22) PCT Filed: Dec. 20, 2023
(86) PCT No.: PCT/SE2023/051289

§ 371 Date: Jun. 21, 2025

(30) Foreign Application Priority Data
Dec. 22, 2022 (SE) 2251560-5

(51) Int. Cl. G06N 5/022

(52) U.S. Cl. CPC G06N 5/022

(57) ABSTRACT

A computer-implemented method for generating furniture assembly instructions is provided. The method comprises receiving first and at least one additional sets of furniture assembly instructions comprising instructions for assembling corresponding first and at least one additional furniture. The method further comprises retrieving assembly metadata being indicative of respective relationships between furniture components of the first and at least one additional furniture modules to be included in a combined furniture module. The method further comprises generating a combined set of furniture assembly instructions for assembling the combined furniture module by combining the first set and the at least one additional set, the combined set providing instructional media of recommended assembly steps to be followed during an assembly procedure of the combined furniture module.

### TECHNICAL FIELD

The disclosure relates generally to assembling furniture. More specifically, the disclosure relates to a computer-implemented method for generating furniture assembly instructions. The disclosure also relates to an associated computerized system and a non-transitory computer-readable storage medium.

### BACKGROUND

Many furniture companies or manufacturers sell their products in disassembled states, which is advantageous for e.g., storage, delivery and cost reasons. Upon receiving a furniture module at a location where the furniture is to be placed, such as a home or office environment, the disassembled furniture first has to be assembled before its functionality can be enjoyed. Many furniture solutions of today are accompanied with assembly instructions indicating what steps that need to be taken in order to properly assemble the furniture. The assembly instructions may be provided in a physical brochure or digitally via the furniture companies' or manufacturers' websites.

Some companies or manufacturers offer large and complex furniture solutions, such as a complete kitchen, bathroom, cloakroom, mix-and-match furniture, or otherwise a plurality of sizeable furniture modules that cannot be physically delivered as a single furniture module for various reasons. Such reasons may include dimensional, packaging, or delivery-related restrictions. In these situations, customers ordering the items will be provided with a plurality of furniture modules, and each module will be accompanied by a respective assembly instruction. This will easily become overwhelming for the customer as it is very likely to be unclear where to start and how to proceed during an assembly procedure. Moreover, it can quickly become difficult to know which furniture module is associated with what furniture, and how they are to be managed one by one or simultaneously. It is therefore onerous, if not impossible, to figure out the most optimal assembly procedure.

The present inventors have realized the above-mentioned deficiencies of the prior art, and are herein presenting improvements in relation to generation of furniture assembly instructions that seek to solve, or at least mitigate, one or more of these deficiencies.

### SUMMARY

According to a first aspect of the disclosure, a computer-implemented method for generating furniture assembly instructions is provided. The method comprises receiving a first set of furniture assembly instructions comprising instructions for assembling a first furniture module, the first furniture module comprising a plurality of furniture components; receiving at least one additional set of furniture assembly instructions comprising instructions for assembling at least one additional furniture module, each one of the at least one additional furniture module comprising a plurality of furniture components; retrieving, for each one of the first set and the at least one additional set, respectively, assembly metadata being indicative of respective relationships between the furniture components to be included in a combined furniture module comprising the first furniture module and the at least one additional furniture module wherein the assembly metadata is retrieved from said first and additional sets of furniture assembly instructions, and/or a storage resource; and based on the retrieved assembly metadata, generating a combined set of furniture assembly instructions comprising instructions for assembling the combined furniture module by combining the first set and the at least one additional set, the combined set providing instructional media of recommended assembly steps to be followed during an assembly procedure of the combined furniture module.

The present disclosure according to the first aspect advantageously provides an optimal assembly procedure for large and complex furniture solutions, as discussed in the Background section above. “Combined” is in this sense to be interpreted as a joint arrangement of assembly instructions for the assembly of a plurality of furniture modules that may be ordered according to various aspects. Some technical benefits of providing the combined set of assembly instructions are related to a correct, clear, time-efficient, safe, cheap and ergonomically satisfactory assembly procedure. Additional advantageous technical benefits may be realized by the various embodiments/examples/appended claims/clauses described in the present disclosure.

In one or more embodiments, the method further comprising receiving one or more assembly optimization inputs configured to cause one or more changes to the combined set of furniture assembly instructions when applied in the generation thereof, and wherein said generating of the combined set comprises determining an order of the recommended assembly steps based on the one or more assembly optimization inputs.

In one or more embodiments, the order comprises a starting furniture component of either one of the first furniture module or the at least one additional furniture module; and after the starting furniture component and for all remaining furniture components to be included in the combined furniture module, a plurality of subsequent furniture components of either one of the first furniture module or the at least one additional furniture module.

In one or more embodiments, the order is determined by combining weighted values of a plurality of the one or more assembly optimization inputs.

In one or more embodiments, the one or more assembly optimization inputs comprise environmental data of the physical environment in which the combined furniture module is to be assembled.

In one or more embodiments, the environmental data is obtained by means of a near real-time 3D scanning tool and/or a room layout file.

In one or more embodiments, the method further comprising receiving user input through an augmented reality interface, wherein the user input defines a virtual bounding volume that is virtually placed in a 3D space representation of the physical environment where the combined furniture module is to be assembled, wherein the virtual bounding volume is adapted to be further manipulated through the augmented reality interface based on one or more intersections in 3D space between the virtual bounding volume and 3D data corresponding to physical objects located in the physical environment, wherein the environmental data is obtained by means of the manipulated virtual bounding volume.

In one or more embodiments, the one or more assembly optimization inputs comprising furniture data of the first furniture module and the at least one additional furniture module.

In one or more embodiments, the furniture data being obtained from 3D object models and/or product lists.

In one or more embodiments, the one or more assembly optimization inputs comprising safety data of external restrictions affecting the assembly procedure.

In one or more embodiments, the one or more assembly optimization inputs comprising assembler data of one or more persons performing the assembly procedure.

In one or more embodiments, the assembly metadata comprising, for each one of the first and additional set(s), degrees of compatibility of said furniture components to be included in the combined furniture module.

In one or more embodiments, the instructional media of the recommended assembly steps being provided in a user-controllable interface, the user-controllable interface being a textual interface, a graphical interface, an auditory interface, and/or an augmented reality interface.

In one or more embodiments, the user-controllable interface being configured to receive user instructions to selectively step through the recommended assembly steps.

In one or more embodiments, the method further comprising compiling the combined set of assembly instructions such that it can be provided as a physical brochure.

In one or more embodiments, said retrieving of the assembly metadata being triggered by receiving a user request to combine the first set and the at least one additional set into the combined set of furniture assembly instructions.

In one or more embodiments, said receiving of the first set of furniture assembly instructions involving scanning a first identifier being arranged on any of the plurality of furniture components of the first furniture module, on a furniture package thereof and/or on a furniture assembly manual thereof, and requesting the first set of furniture assembly instructions from a storage resource, such as a cloud-based storage resource, using said first identifier as a reference; and said receiving of the at least one additional set of furniture assembly instructions involving scanning a respective second identifier being arranged on any of the plurality of furniture components of said each one of the at least one additional furniture module, on a furniture package thereof and/or on a furniture assembly manual thereof, and requesting the at least one additional set of furniture assembly instructions from a storage resource, such as a cloud-based storage resource, using said respective second identifier as a reference.

In one or more embodiments, the method further comprising scanning an identifier on any of the furniture components, furniture modules, or furniture packages thereof, and using the identifier as a reference, requesting placement-related information of said furniture components, furniture modules, or furniture packages thereof based on the recommended assembly steps.

According to a second aspect, a computerized system for generating furniture assembly instructions is provided. The system comprises one or more processor devices being configured to receive a first set of furniture assembly instructions comprising instructions for assembling a first furniture module, the first furniture module comprising a plurality of furniture components; receive at least one additional set of furniture assembly instructions comprising instructions for assembling at least one additional furniture module, each one of the at least one additional furniture module comprising a plurality of furniture components; retrieve, for each one of the first set and the at least one additional set, respectively, assembly metadata being indicative of respective relationships between the furniture components to be included in a combined furniture module comprising the first furniture module and the at least one additional furniture module wherein the assembly metadata is retrieved from said first and additional sets of furniture assembly instructions, and/or a storage resource; and based on the retrieved assembly metadata, generate a combined set of furniture assembly instructions comprising instructions for assembling the combined furniture module by combining the first set and the at least one additional set, the combined set providing instructional media of recommended assembly steps to be followed during an assembly procedure of the combined furniture module.

According to a third aspect, a non-transitory computer-readable storage medium is provided. The non-transitory computer-readable storage medium comprises instructions, which when executed by a processor device, cause the processor device to perform the method of the first aspect.

Similar technical advantages as realized by the first aspect may correspondingly be realized by the second and third aspects, respectively. Moreover, any of the embodiments associated with the first aspect may alternatively be associated with the second or third aspect.

The above aspects, accompanying claims/clauses, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIGS. 1A-B are exemplary illustrations showing generation of a combined set of furniture assembly instructions for assembling a combined furniture model.

FIG. 2 is an exemplary schematic diagram illustrating data relating to the generation of a combined set of furniture assembly instructions.

FIG. 3A is an exemplary schematic diagram illustrating a computerized system which may be configured to generate a combined set of furniture assembly instructions.

FIG. 3B is an exemplary computing environment for the computerized system of FIG. 3A.

FIG. 4 is an exemplary flowchart method for generating furniture assembly instructions.

FIG. 5 is an exemplary computer-readable storage medium.

### DETAILED DESCRIPTION

Aspects set forth below represent the necessary information to enable those skilled in the art to practice the disclosure.

The skilled person will appreciate that the present disclosure refers to various sets of furniture assembly instructions. These sets of furniture assembly instructions are instructions provided in a digital format, i.e., being computerized. Hence, when referring to receipt and generation of the sets of furniture assembly instructions, this is to be interpreted as receipt and generation in a digital sense, for instance by means of inputting, processing and outputting the sets of furniture assembly instructions as data instructions. The term set merely refers to a collection of data, in this case a collection of data pertaining to furniture assembly instructions.

Before delving into the particulars of the respective exemplary illustrations of the figures, a typical exemplary use case of applying some of the inventive aspects will be explained. The skilled person will appreciate that this is just an exemplary typical use case and is thus not to be construed as limiting to the scope of the present disclosure. A typical scenario is that a user is interested in purchasing a new furniture solution, such as a kitchen furniture solution. The user accordingly browses through a large number of various furniture modules (or components, solutions and/or combinations thereof) in order to find a desirable kitchen furniture solution. These modules will be dragged in and out from a visual tool to plan an activity or space digitally for a real world application (hereinafter referred to as a home planner application, for reasons of brevity) running on a computer of the user, such that the user may at all times during the browsing process view a current visualization of the selected kitchen furniture solution. Once the user is satisfied with the choices, the user will perform an action, such as clicking a button, thereby indicating a completion of browsing. Accordingly, corresponding sets of assembly instructions for the selected furniture modules are sent to a server for further processing, together with a request for combining the respective assembly instructions into a combined set of assembly instructions. Upon receipt, the server will retrieve assembly metadata associated with the components to be included in the kitchen furniture solution such that relationships between said components can be established. The server will then, based on the retrieved assembly metadata, perform said combination of the individual sets such that the combined set is generated. The combined set will provide instructional media of recommended assembly steps that are sent back to the user such that the kitchen furniture solution can be assembled, while realizing one or more of the technical advantages as discussed in the Summary section. In various embodiments of the disclosure, the user may provide one or more assembly optimization inputs such that additional benefits are obtained. In slightly alternative examples, the combined set of assembly instructions may be generated once the furniture are delivered to the user's home. A similar assembly instruction generation procedure may be realized also in this case.

It is to be understood that the combination as explained throughout the present disclosure does not necessarily include combining all instructions from all of the sets of furniture assembly instructions. One or more instructions may be omitted in the combination. The combination procedure is therefore not necessarily to be interpreted as a full combination, but rather as at least partial combination. In other words, the sets of furniture assembly instructions may in one or more of the aspects, examples, embodiments, and so forth, as explained herein, be at least partly combined into the combined set of furniture assembly instructions.

Moreover, it should be understood that the combined set of furniture assembly instructions is to be generated on a module level, i.e., how to combine the modules. However, since each module comprises components, the combined set of furniture assembly instructions will indirectly be generated also on a component level, i.e., how to combine the components. To this end, components of one module may be combined with components of the same or another module, in any order that is considered preferred, as will be described in the present disclosure.

Moreover, it should be understood that the term “assembly” involves performing some step in order to proceed from one initial state, to any number of intermediate states, to a final state, where the initial state is a generally more disassembled/unfinished state compared to the intermediate/final states.

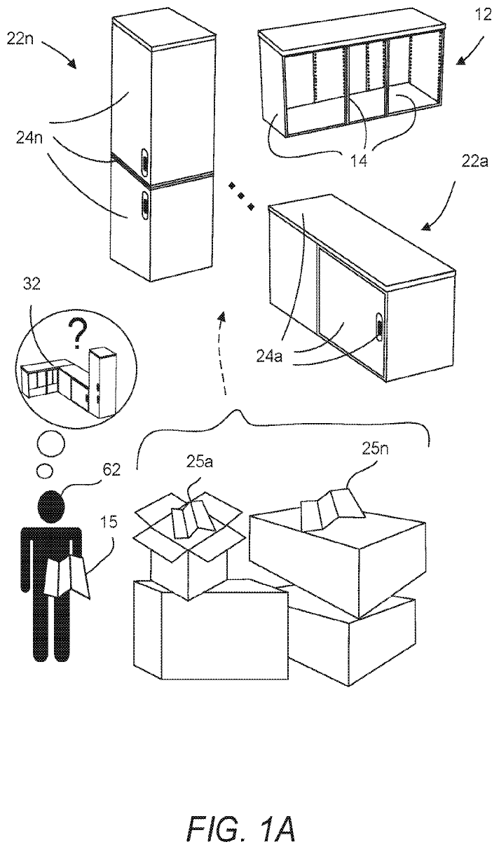

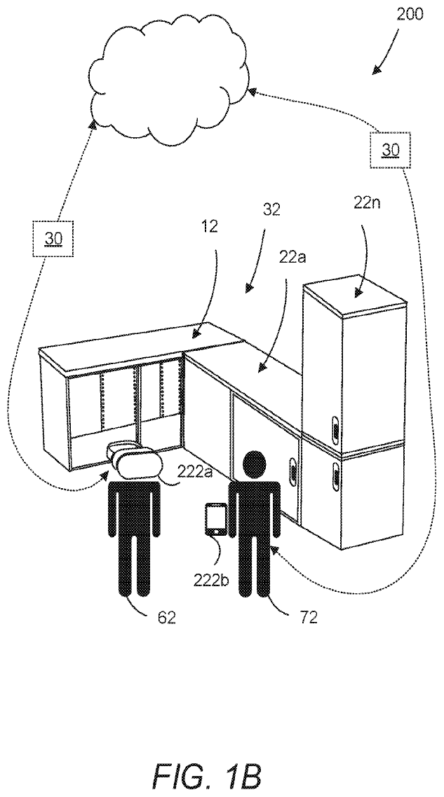

FIGS. 1A-B generally illustrate the generation of furniture assembly instructions according to an exemplary embodiment. The problem referred to in the Background section is visualized in FIG. 1A. In FIG. 1B, the problem has been solved by means of the generation of combined furniture assembly instructions. One or more of the technical effects referred to in the Summary section are accordingly realized. Hence, FIG. 1A is to be seen as current prior art where a person is overwhelmed by the number and disorganized order of furniture packages being delivered. FIG. 1B is to be seen as one (out of many) scenario(s) where the problem has been solved by providing combined furniture assembly instructions by means of at least some of the inventive teachings of the present disclosure.

In FIG. 1B, a person 62 has had a plurality of furniture packages delivered to a location where a combined furniture module 32 is to be arranged. The combined furniture module 32 comprises a first furniture module 12 and one or more additional furniture modules 22a-n. In this particular example, the additional furniture modules 22a-n are two furniture modules, i.e., the combined furniture module 32 comprises three different furniture modules 12, 22a, 22n. The skilled person will however appreciate that the combined furniture module 32 may comprise any number of additional furniture modules 22a-n.

The first furniture module 12 and the one or more additional furniture modules 22a-n may be any type of furniture, such as furnishing, appliances or equipment, typically found at any suitable location, e.g. homes, offices, restaurants, coffee shops, hotels, and so forth. In this particular example, the first furniture module 12 is one type of kitchen sideboard furniture, the additional furniture module 22a is another type of kitchen sideboard furniture, and the additional furniture module 22n is a combined refrigerator/freezer furniture. To this end, the combined furniture module 32 is a kitchen furniture solution comprising three parts that are to be combined with one another. In alternative examples, the combined furniture module 32 is any other combination of furniture modules among the furniture found in locations mentioned above.

As further seen in FIG. 1A, each one of the furniture modules 12, 22a-n comprises respective pluralities of furniture components 14, 24a-n. The furniture components 14, 24a-n may be pieces that together make up the associated furniture module 12, 22a-n once they have been put together. In the exemplary kitchen sideboard furniture 12, the furniture components 14 comprise base and top components being interconnected by balk components on one side and panel components on the opposing side. Similar structures may be seen also for the other kitchen sideboard furniture and the combined refrigerator/freezer furniture.

Four furniture packages are shown in FIG. 1A. This is by no means to be interpreted as limiting to the scope of the present disclosure. In alternative examples, any number of furniture packages may comprise any number of furniture components 14, 24a-n.

Accompanied with the delivery of the furniture packages are corresponding furniture assembly manuals 15, 25a-n comprising instructions of how to assemble each one of the furniture modules 12, 22a-n. In this example, the furniture assembly manuals 15, 25a-n are provided as physical brochures, although digital manuals may also be provided, or possibly combinations thereof. As visualized by FIG. 1A, the person 62 does not initially know how to assemble the combined furniture module 32 using the best possible approach, because no guidance as to how each one of the separate furniture modules 12, 22a-n are to be combined to the combined furniture module 32 is taught from the prior art.

In FIG. 1B, a computerized system 200 is shown. The computerized system 200 is configured to generate a combined set 30 of furniture assembly instructions (hereinafter referred to as the combined set 30, or simply set 30, for reasons of brevity). The combined set 30 may be displayed by one or more mobile devices 222 thanks to the provisions of the present disclosure. In this example, the mobile devices 222a-b correspond to a HMD device and a smart tablet, but this is not to be seen as limiting to the scope of the present disclosure. Accordingly, the same person 62 who was overwhelmed by the delivery of the furniture boxes in FIG. 1A can now satisfactorily assemble the combined furniture model 32 as said person 62 is provided by the combined set 30. Possibly, the person 62 may be accompanied with a co-assembler 72 who also may enjoy the provisions of the present disclosure by being guided by the combined set 30.

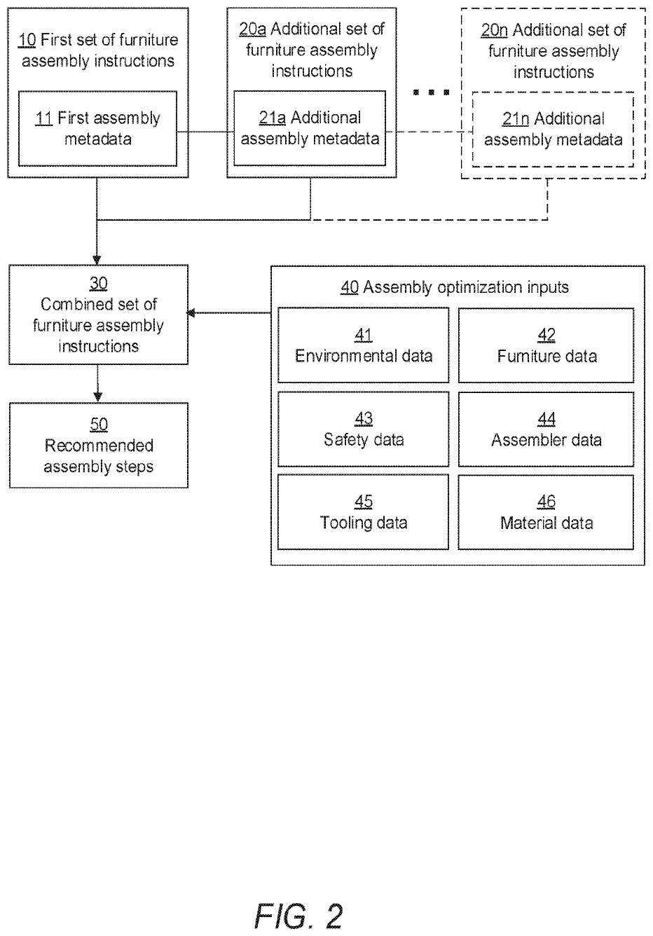

FIG. 2 is an exemplary schematic diagram illustrating data relating to the generation of a combined set 30 of furniture assembly instructions. The combined set 30 is generated based on a combination of a first set 10 of furniture assembly instructions (hereinafter referred to as the first set 10, or simply set 10, for reasons of brevity) and at least one additional set 20a-n of furniture assembly instructions (hereinafter referred to as the additional set(s) 20a-n, or simply set(s) 20a-n, for reasons of brevity).

The first set 10 comprises instructions for assembling a first furniture module, such as the module 12 shown in FIGS. 1A-B. Similarly, each one of the additional sets 20a-n respectively comprises instructions for assembling at least one additional furniture module, such as the modules 22a-n shown in FIGS. 1A-B. To this end, the sets 10, 20a-n comprise instructions that are sufficient for an assembler to be able to assemble each one of the furniture modules, with no regard taken as to how the separate modules are subsequently to be combined into a combined furniture module, such as the module 32 shown in FIGS. 1A-B.

The first and additional sets 10, 20a-n may be received by scanning one or more identifiers being arranged on any furniture module, component, package thereof, and/or furniture assembly manual thereof. Using said scanned identifiers as references, the first and additional sets 10, 20a-n can be requested from a storage resource, such as a cloud-based storage resource. The one or more identifiers and the scanning thereof may be based on any commonly known scanning technology, included but not limited to Quick Response (QR), barcodes or other optical scanning technologies, Radio frequency Identification (RFID), Ultra-wideband (UWB), Near-field communication (NFC), Bluetooth Low Energy (BLE) or other short-range wireless radio frequency communication technologies.

Alternatively, the first and additional sets 10, 20a-n may be retrieved from an online source, such as a furniture manufacturer or company's website. Yet alternatively, the first and additional sets 10, 20a-n may be received by combining the above-described embodiments. For example, the first set 10 may be received by using the scanning technique, and either one of the additional sets 20a-n may be received from an online source. The skilled person realizes any alternative such combination of techniques for receiving the first and additional sets 10, 20a-n.

Further seen in FIG. 2 is first and additional assembly metadata 11, 21a-n, for the respective first and additional sets 10, 20a-n. The assembly metadata 11, 21a-n is indicative of relationships between furniture components that are to be included in the combined furniture module.

The first assembly metadata 11 may indicate degrees of compatibility of the furniture components to be included in the combined furniture module. What this means is generally that each furniture component in the combined furniture module is to some degree related to the other furniture components in the same combined furniture module. The compatibility degree may be spatial coordinates of the respective furniture components once arranged together in the combined furniture module. Consider the example where a combined kitchen solution has two corner modules and two center modules, each furniture component of the respective modules being spatially related to one another in the combined kitchen solution. The first corner module may be located in a first corner with spatial coordinates x₁, y₁, z₁, the first center module may be located next to the first corner module with spatial coordinates x₂, y₁, z₁, the second center module may be located next to the first center module with spatial coordinates x₂, y₁, z₂, and the second corner module may be located vertically above the second center module with spatial coordinates x₂, y₂, z₂. The shape of the combined kitchen solution will thus be generally L-shaped, viewed from above, where one end accommodates two (vertically) stacked modules.

In one example, a first kitchen sideboard may be connected to a second kitchen sideboard in a predefined number of ways, and the first kitchen sideboard may be connected to a third kitchen sideboard in another predefined number of ways. In this example, the predefined number of ways corresponds to the compatibility degree. The first assembly metadata 11 indicating degrees of compatibility may thus determine which one of the relationships (first/second or first/third) that is the most compatible by comparing the predefined numbers. If the first and second kitchen sideboards can be connected in five different ways, while the first and third kitchen sideboards can be connected in one different way, this may be an indication that the first/second kitchen sideboards are more compatible than the first/third kitchen sideboard. To this end, the assembly metadata 11 may indicate a higher degree of compatibility for the first/second kitchen sideboard compared to the first/third kitchen sideboard. Clearly, the same would apply for the respective relationships between the second kitchen sideboard and the first or third kitchen sideboard, or any number of additional and/or other types of furniture modules, e.g., drawers, or other such furniture modules.

The conditions “how many ways X can be combined with Y” and “where X is to be arranged in spatial relation to Y”, where X and Y are furniture components or modules, as explained according to the examples above, are just exemplary conditions that may be considered when indicating the degrees of compatibility. Similarly, the relation in terms of spatial coordinates of the modules and/or components included therein are other exemplary conditions of compatibility degrees. Any additional or alternative condition can alternatively be considered and weighed against one another, for instance, how well they are compatible, how many additional furniture modules that they can be assembled with, how easily they can be combined, to name a few conditions.

The assembly metadata 11, 21a-n may be retrieved from a home planner application. A furniture solution may be virtually planned in the home planner application, where each step of the planning includes retrieving assembly metadata 11, 21a-n of various virtual furniture arrangements. The virtual furniture arrangements may be updated each time one or more furniture modules are added, removed, or modified using the home planner application. The home planner application may include the sets 10, 20a-n, and the assembly metadata 11, 21a-n may thus be retrieved from the sets 10, 20a-n via the home planner application. Alternatively or additionally, the assembly metadata 11, 21a-n may be retrieved from a storage resource, such as a cloud-based storage resource. The external service may be configured to communicate with the home planner application.

Based on the retrieved assembly metadata 11, 21a-n, the combined set 30 is generated by combining the first and second sets 10, 20a-n. Hence, based on how the respective furniture components to be included in the combined furniture module are related, the combined set 30 is accordingly generated. The combined set 30 provides instructional media of recommended assembly steps 50 to be followed during an assembly procedure of a combined furniture module, such as the combined furniture module 32 as seen in FIGS. 1A-B.

FIG. 2 further shows a plurality of assembly optimization inputs 40. In contexts of the present disclosure, the assembly optimization inputs 40 may refer to information or instructions provided to the combined set 30 to improve the efficiency of the assembly process. The assembly optimization inputs 40 are configured to cause one or more changes to the combined set 30 when applied in the generation thereof. The one or more changes may pertain to various different factors, ultimately allowing a more efficient assembly procedure by the recommended assembly steps 50. The assembly optimization inputs 40 may also be understood as configuration or tuning parameters, i.e., parameters that are adapted to optimize the output of the system based on the characteristics or requirements of the said assembly optimization inputs 40. One or more of the assembly optimization inputs 40 may be included in a request to combine the sets 10, 20a-n into the combined set 30. The request may be user-triggered. Alternatively, assembly optimization inputs 40 may be included as separate input after the sets 10, 20a-n have been combined. Other variations may also be realized. Regardless of whether the assembly optimization inputs 40 are sent separately or included in the combination request, generating the combined set 30 involves determining an order of the recommended assembly steps 50 based on the assembly optimization inputs 40. Alternatively put, the assembly optimization inputs 40 may assist in the generation of the combined set 30 such that they are optimized with respect to a plurality different scenarios.

The order indicates how each one of the respective furniture components of all of the furniture modules should be assembled in a comprehensive manner. The order may therefore comprise a starting furniture component of either one of the first or additional furniture modules, as determined by either one of the first or additional sets 10, 20a-n. After selection of the starting furniture component, and for all remaining furniture components to be included in the combined furniture module, the order further comprises a plurality of subsequent furniture components. The plurality of subsequent furniture components may be (selected) from any one of the furniture modules. For example, the starting furniture component may be from a second furniture module, the following two furniture components may be from a third furniture module, the following four furniture components may be from the first furniture module and a final furniture component may be from the fourth furniture module. The order may be determined such that the reachability of the assembler is optimal (i.e., the arranging of a module or component shall preferably not restrict the reachability of a subsequent module or component). Any alternative variations of appropriate order of assembly based on the assembly optimization inputs 40 may be realized.

The present disclosure is not limited to any particular order. The order is preferably as advantageous as possible in terms of correctness, clearness, time-efficiency, safety, cost and ergonomic satisfaction.

A plurality of different assembly optimization inputs 40 are seen in FIG. 2. These are to be interpreted as data taken into account during the combining of first and additional sets 10, 20a-n in order to derive the optimal assembly procedure through the provided instructional media.

The assembly optimization inputs 40 may comprise environmental data 41 of the physical environment in which the combined furniture module is to be assembled. The environmental data 41 may include size and/or dimensions of the room, other objects in the room (e.g., already present furniture or fixed objects such as ducts, windows, walls, ceiling, etc.), or other such information that defines how the room confines the assembly space of the combined furniture module to be assembled. Accordingly, the environmental data 41 may determine where in the physical environment (for instance in a certain corner of the room) the various furniture components should be assembled.

The environmental data 41 may comprise information relating to what type of room the physical environment is, i.e., bathroom, sanitary room, children's room, kitchen, attic, workshop, and so forth. Since all of these rooms are typically associated with different activities, they may be constructed differently. For instance, material selection, textures or other such details may be taken into account in the environmental data 41.

The environmental data 41 may comprise furniture component and/or module adaptation information based on the environment. The combined set 30 being optimized by the environmental data 41 comprising said adaptation information can thus include instructions of modifying certain furniture components or modules based on how the environment looks like. To this end, upon the environmental data 41 indicating that a certain module is to be arranged at a certain location where some other object of the room is located (e.g., already present furniture or fixed objects such as ducts, windows, walls, ceiling, etc.), the adaptation information may cause the combined set 30 to instruct the assembler into modifying a portion of any furniture component or module such that it fits better with said other object of the room. For instance, the assembler may be instructed to saw out a hole for a pipe or a part of a door so that it fits under a sloping ceiling, or other such scenarios realized by the skilled person.

The environmental data 41 may comprise additional environmental data of locations adjacent to the location where the combined furniture module is to be placed. Hence, present disclosure allows for the combined furniture module to be arranged in one location, e.g., a first room, and then be carried over to a second location, e.g., a second room, where it is to be placed. A warning may be generated and provided, for instance to the mobile device of the assembler, indicating that the assembled combined furniture module may not fit through a doorway or aisle to reach the (possibly) final destination. To this end, the following steps can be realized in order: 1) parts of the combined furniture module are assembled at the first location, 2) the user is warned of a maximum number of possible steps that can be carried over to the second room, 3) the (partly completed) furniture module is carried over to the second location, 4) the assembly of the furniture module is completed at the second location. Other similar approaches may be realized.

In some embodiments, the environmental data 41 is obtained by means of a near real-time 3D scanning tool. Near real-time 3D scanning tools are known in the art and may, for instance, include LiDAR, stereo camera systems, depth camera systems, structured light projection systems, and so forth. The near real-time 3D scanning tools may be implemented by a mobile device, such as the HMD device 222a or the smart tablet 222b as shown in FIG. 1B. Additionally or alternatively, the environmental data 41 may be obtained by means of a room layout file. The room layout file may be a retrieved from a home planner application, official sources (e.g., drawings from authorities), builders, or other sources. The room layout file may be a CAD file, e.g., STEP, QIF, JT or 3D PDF, or other data-readable files, e.g., json, yaml, xml, to name a few examples.

Alternatively or in addition to the room layout file and the near real-time 3D scanning tools, the environmental data 41 may in some embodiments be obtained by means of a manipulated virtual bounding volume. Defining a manipulated virtual bounding volume through an augmented reality interface is, as such, known from the European patent application no. 21171682 filed by the present application. The details described therein will not be covered in the present disclosure. However, the technology generally involves a first step of receiving user input for defining a virtual bounding volume that is placed in a 3D space representation of the physical environment. The user input may be received through an augmented reality interface, for instance by the HMD device 222a or the smart tablet 222b as shown in FIG. 1B. Moreover, the technology generally involves further manipulating the virtual bounding volume through the augmented reality interface based on one or more intersections in 3D space between the virtual bounding volume and 3D data corresponding to physical objects located in the physical environment. Such physical objects were described above (e.g., already present furniture or fixed objects such as ducts, windows, walls, ceiling, etc.). The physical environment thus confines a space of the virtual bounding volume, and the environmental data 41 is obtained by means of said space of the virtual bounding volume.

The above means for obtaining the environmental data 41 may be combined. To this end, a first scan/layout of the room can be obtained, and then be further confined by the virtual bounding volume such that a very precise space can be defined where the combined furniture module is to be assembled. This procedure may additionally involve, during the assembly procedure, creating one or more additional virtual bounding volumes, where each one of said additional bounding volumes corresponds to a respective furniture module to be arranged. The additional bounding volumes may be provided one after the other in a subsequent order, thereby generally following the recommended assembly steps 50 during the assembly procedure.

The assembly optimization inputs 40 may comprise furniture data 42 of the furniture modules that make up the combined furniture module. The furniture data 42 may comprise size or dimensions of the furniture modules and/or for each furniture component thereof, weight information, furniture type (e.g., wall-hanging object, free standing object, ceiling object, floor object), furniture-room type (e.g., furniture typically arranged in a particular room such as kitchen objects/cloakroom objects), style groups (e.g., exclusive furniture, cozy furniture, Scandinavian furniture, retro furniture, rustic furniture), and other data relating to furniture in general. The furniture data 42 may be retrieved as stored 3D product models of the furniture and/or product lists, the 3D models and/or product lists comprising internal data or metadata defining properties of said furniture. The 3D product models and/or product lists may be retrieved from a storage resource, such as a cloud-based storage resource.

The assembly optimization inputs 40 may comprise safety data 43 of external restrictions affecting the assembly procedure. The safety data 43 may comprise information relating to fire hazards (e.g., this furniture component cannot be placed there because it is too close to a radiator that may cause a fire, or this furniture component cannot be placed there because it blocks a fire exit), ventilation requirements (e.g., this furniture component cannot be placed there because it negatively affects the air flow of the room), or other similar safety-related information. The safety data 43 may be retrieved from an external service, for instance authorities, fire departments, regulatory/compliance services, and so forth.

The assembly optimization inputs 40 may comprise assembler data 44 of one or more persons performing the assembly procedure. The combined set 30 may thus be personalized to a high degree such that the instructions provided by the instructional media is tailored to the person(s) assembling the combined furniture module.

The assembler data 44 may comprise information relating to the number of assemblers. In this example, the instructional media may recommend that a first person starts with the assembly of a particular furniture module, and that one or more additional persons start with the assembly of other furniture modules. The total assembly procedure may thus be parallelized such that a much more expedient assembly is realized. As an example, a first person may be instructed to start in a first corner of the room with a first furniture module, and a second person may simultaneously be instructed to start in a second corner of the room with a second furniture module. Subsequent steps may include instructions for collectively assembling towards the middle of the room, thereby interconnecting the two “subsets” of the combined furniture module.

The assembler data 44 may comprise information relating to the craftsmanship of the person(s) assembling the combined furniture module. For instance, if it is known that the assembler is a skilled craftsman with respect to assembly of kitchen solutions, one or more steps of the instructional media may be omitted, simplified, combined, or be associated with other suitable actions that tailor the assembly based on the person's assembly skill.

The assembler data 44 may comprise information of a person's physical appearance. This information may affect certain steps of the assembly procedure, for instance if the height of a person prevents or enables the assembly of a certain module/component before another module/component.

The assembler data 44 may comprise disability information. Disability information may provide additional guidance for people having one or more disabilities. For instance, the way that certain assembly steps are to be performed can be adjusted if it is known that the assembler has one or more mobility impairments, is missing a limb, has difficulties with utilizing some tools, or any other disability which involves not being able to perform some assembly steps. These steps may accordingly be adjusted such that they are to be performed using some alternative approach that does not hinder the disabled person's ability to assemble the combined furniture module.

The assembly optimization inputs 40 may comprise tooling data 45 of which tool to be used during the assembly procedure. The tools to be used may be any one of the tools used for the respective furniture modules, or any additional/alternative tool that can be used to assemble the combined furniture module. Tools commonly used for furniture assembly, e.g., wrench, hammer, Allen key, screwdriver, and so forth, can be provided by the tooling data 45.

The assembly optimization inputs 40 may comprise material data 46 of which items to be used during the assembly procedure. Items commonly used during furniture assembly includes screws, bolts, tacks, nails, etc. The material data 46 may thus include any number of usable items from the respective sets 10, 20a-n, or additional usable items not accounted for in the respective sets 10, 20a-n which may nevertheless be of importance for the assembly of the combined furniture module.

Any one of the assembly optimization inputs 40 as described above can be derived from various sources. In addition to the examples that are described above, it is also understood that some assembly optimization inputs 40 may be derived directly from the first and additional sets 10, 20a-n of furniture assembly instructions, from a storage resource, such as a cloud-based storage resource, or from user input (e.g., from a mobile device or a home planner application). For instance, a user may provide exemplary assembler data 44 by specifying his/her movement impairment, the height of the user, how many people are assembling, and/or a skill level of the assembler and/or the number of assemblers.

The order of the recommended assembly steps 50 may be calculated based on the one or more assembly optimization inputs 40 as discussed above. Alternatively, the order of the recommended assembly steps 50 may be calculated based on combined weighted values of a plurality of the one or more assembly optimization inputs 40 as discussed above. In these embodiments, each assembly optimization input 40 may be given an assembly coefficient which indicates a degree of importance in relation to the other assembly optimization inputs 40. For instance, the environmental data 41 may be given a “1”, the furniture data 42 a “2”, the safety data 43 a “3”, the assembler data 44 a “4”, the tooling data 45 a “5”, and the material data 46 a “6”, where “1” is the most important data and “6” is the least important data. Accordingly, when generating the combined set 30, the assembly optimization inputs 40 are weighed with respect to one another such that the environmental data 41 is given precedence over all the other data, or the other way around, or practically in any possible order. This may be important in some scenarios where the most optimal assembly optimization input 40 cannot be selected for all of the data 41, 42, 43, 44, 45, 46 due to said data 41, 42, 43, 44, 45, 46 contradicting one another. Such a scenario may be realized where the environmental data 41 indicates that a certain furniture component is to be placed at a certain location, but the safety data 43 indicates that this is not appropriate due to fire hazards. Hence, in this particular example the safety data 43 may be given precedence and the combined set 30 may accordingly indicate the placement of said furniture component primarily based on the safety data 43. The skilled person will appreciate that any suitable weighing scheme of the assembly optimization inputs 40 can be realized, none of which are to be seen as limiting to the scope of the present disclosure. In some examples, the combined set 30 may present as instructional media n number of alternative recommended steps 50 where different weighing schemes are presented that offer slight variations in the assembly procedure. Hence, the user may choose between different alternative recommended steps 50 that depend on the used weighing scheme.

The generation of the combined set 30 may be based on previously generated generations of combined sets of furniture assembly instructions. To this end, the generation of the combined set 30 may be based on self-learning features. Relevant data to be processed by a corresponding self-learning model may include data pertaining to time spent assembling a combined furniture module and the relevant subassembly steps, assembler satisfaction, previous recommendations given, previous assembly optimization inputs 40 taken into account and/or respective weighing thereof, and other data related to the assembly procedure. The self-learning model may be trained on a dataset comprising all of the data described above. Whenever generation of the combined set 30 is performed, the self-learning model may thus perform autonomous classifications of suitable recommended assembly steps 50 to provide based on circumstances relating to previously completed assemblies. The self-learning model may implement any known supervised or unsupervised learning algorithm known in the art, such as binary, multi-class, or multi-label classification and/or clustering algorithms. For instance, algorithms such as logistic regression, support vector machines, kernel estimation, decision trees and/or neural networks may be used. Additionally, the machine learning model may learn from previous classifications by implementing a backpropagation algorithm.

In view of intelligent generation of the combined set, as explained above, one exemplary approach that may be taken for dealing with the known state explosion problem caused by rapid complexity growth involves combining a rapidly exploring random tree (RRT) with a declarative algorithm, such as Goal Oriented Action Planning (GOAP). Together with simulating physical constraints in the data space, the above-explained approach provides intelligent analyses of a manageable number of possible sequences. Subsequently, a working sequence may be selected among said manageable number of possible sequences. Hence, a working sequence may be obtained from among an (almost) infinite number of solutions.

The instructional media of the recommended assembly steps 50 may be provided in a user-controllable interface. The user-controllable interface may be a textual interface. The textual interface may be instructional sentences that can be read by a user, for instance “component X of module A is to be screwed together with component Y of module B in this way, using this tool, and while standing at this location”. The user-controllable interface may be a graphical interface. The graphical interface may provide instructional media in the form of visualizations that guides the user into performing a certain act. This may be shown on a mobile device. The user-controllable interface may be an auditory interface that provides audio guidance. The user-controllable interface may be an augmented reality interface that, using augmented reality visualizations, guides the user to perform a certain act. The user-controllable interface may also be any combination of two or more of the above described interface technologies. The user-controllable interface may be implemented by a user device, such as the exemplary devices 222a-b shown in FIG. 1B.

The user-controllable interface may be configured to receive user instructions to selectively step through the recommended assembly steps 50. To this end, the user may look ahead of which steps are to be performed in the future of the assembly procedure for the combined furniture module, or go back one or more steps to verify that some action was correctly performed.

The combined set 30 may be provided as a physical brochure. Accordingly, the recommended assembly steps 50 may be compiled into a format that, after subsequent provision as a physical brochure (for instance after printing the brochure), is able to be followed by the user. This example corresponds to the scenario shown in FIG. 1A, but with the important different that the furniture assembly manuals 15, 25a-n are effectively being combined into one combined physical manual that takes into account one or more of the inventive aspects of the present disclosure with respect to the generation of the combined set 30 based on the retrieved assembly metadata 11, 21a-n.

Placement-related information of the furniture components, modules or packages thereof, may be requested based on the recommended assembly steps 50. For instance, if the combined set 30 is created, and the user wishes to initiate the assembly procedure, said user might want to know where certain objects are to be placed in the room. This knowledge can be obtained by scanning an identifier on any of the furniture components, modules or packages thereof, and use said identifier as a reference for the requesting. To this end, the assembly procedure may become even more space effective. Placement-related information is thus indicative of a position (for instance coordinates retrieved in response to a 3D room scan) in the physical environment in which the modules are to be arranged. Additionally or alternatively, this knowledge can be obtained from one or more instructional icons attached to the furniture component/module or package thereof.

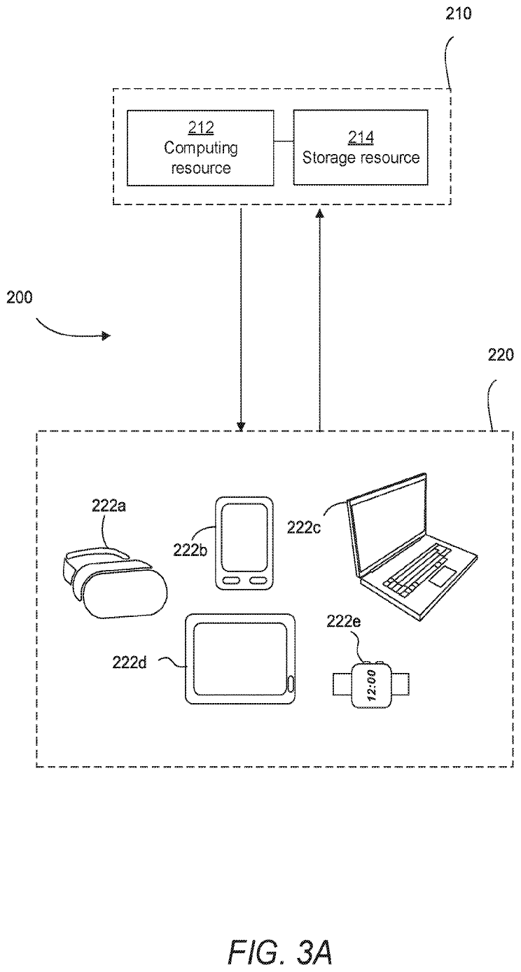

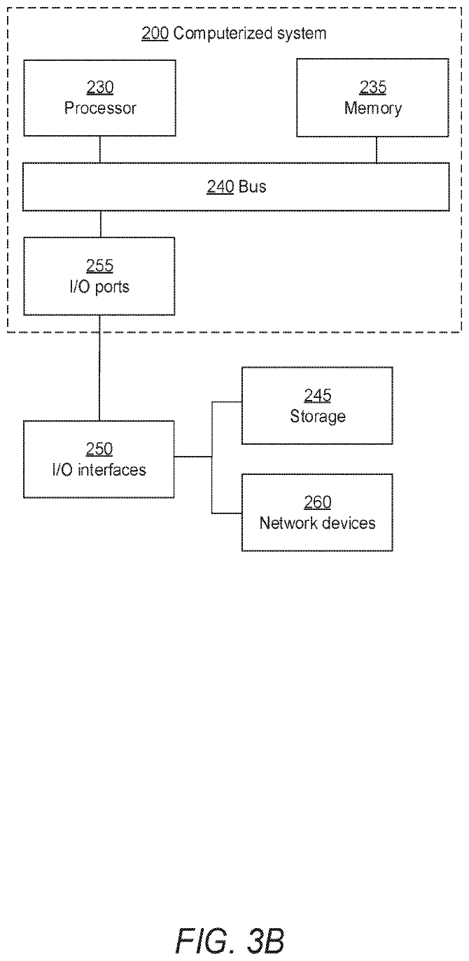

FIG. 3A is an exemplary schematic diagram illustrating a computerized system 200 which may be configured to generate a combined set of furniture assembly instructions. The computerized system 200 comprises a server-side platform 210 and a client-side platform 220.

The server-side platform 210 may be hosted on a cloud-based server being implemented using any commonly known cloud-computing platform technologies, such as Amazon Web Services, Google Cloud Platform, Microsoft Azure, DigitalOcean, Oracle Cloud Infrastructure, IBM Bluemix or Alibaba Cloud. The cloud-based server may be included in a distributed cloud network that is widely and publicly available, or alternatively limited to an enterprise. Alternatively, the cloud-based server may in some embodiments be locally managed as e.g., a centralized server unit. Other alternative server configurations may be realized, based on any type of client-server or peer-to-peer (P2P) architecture. Server configurations may thus involve any combination of e.g. web servers, database servers, email servers, web proxy servers, DNS servers, FTP servers, file servers, DHCP servers, to name a few.

The server-side platform 210 comprises a computing resource 212 and a storage resource 214 being in operative communication. The cloud-based computing resource 212 is configured to perform processing activities as discussed in the present disclosure, such as receiving sets of furniture assembly instructions, retrieving assembly metadata and generating the combined set of furniture assembly instructions. To this end, the cloud-based computing resource 212 comprises one or more processor devices configured to process data associated with the generation of the furniture assembly instructions.

The storage resource 214 may be maintained by and/or configured as a cloud-based service, being included with or external to the cloud-based computing resource 110. Connection to the storage resource 214 may be established using DBaaS (Database-as-a-service). For instance, the storage resource 214 may be deployed as a SQL data model such as MySQL, PostgreSQL or Oracle RDBMS. Alternatively, deployments based on NoSQL data models such as MongoDB, Amazon DynamoDB, Hadoop or Apache Cassandra may be used. DBaaS technologies are typically included as a service in the associated cloud-computing platform.

The client-side platform 220 comprises one or more computing devices 222a-e. In this particular example, the computing devices are mobile devices including a head-mounted display 222a, a smartphone 222b, a laptop computer 222c, a smart tablet 222d and a smartwatch 222e. However, the computing devices may also be stationary devices, such as a stationary computer. The devices 222a-e may be operable by a user. The devices 222a-e may be configured to communicate with the server-side platform 210, for instance communicating the sets of assembly instructions, and to receive the generated combined set of furniture assembly instructions.

Alternatively, the computing devices 222a-e may be configured to perform processing activities as discussed in the present disclosure, such as receiving sets of furniture assembly instructions, retrieving assembly metadata and generating the combined set of furniture assembly instructions. Hence, the functionality as described with reference to the cloud-based computing resource 212 may alternatively be performed by any of the computing devices 222a-e, or both the cloud-based computing resource 212 and the computing devices 222a-e.

Communication between the server-side platform 210 and the client-side platform 220, i.e., each one of the computing devices 222a-e, may be enabled by means of any short-range or long-range wireless communication standards known in the art. For instance, the wireless communication may be enabled by technologies included but not limited to IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, any form of proximity-based device-to-device radio communication, LTE Direct, W-CDMA/HSPA, GSM, UTRAN, LTE or Starlink.

As shown in FIG. 3B, the system 200 may include a number of units known to the skilled person for implementing the functionalities as described in the present disclosure. The system 200 may comprise one or more computing units capable of including firmware, hardware, and/or executing software instructions to implement the functionality described herein. The system 200 may comprise one or more processor devices (may also be referred to as a control unit) 230, one or more memories 235 and one or more buses 240. The processor devices 230 may be included in the computing devices 222a-e and the cloud-based computing resource 212, respectively. The system 200 may include at least one computing device having the processor device 230. A system bus 240 may provide an interface for system components including, but not limited to, the memories 235 and the processor devices 230. The processor device 230 may include any number of hardware components for conducting data or signal processing or for executing computer code stored in the memories. The processor device 230 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device 230 may further include computer executable code that controls operation of the programmable device.

The system bus 240 may be any of several types of bus structures that may further interconnect to a memory bus (with or without a memory controller), a peripheral bus, and/or a local bus using any of a variety of bus architectures. The memories 235 may be one or more devices for storing data and/or computer code for completing or facilitating methods described herein. The memories 235 may include database components, object code components, script components, or other types of information structure for supporting the various activities herein. Any distributed or local memory device may be utilized with the systems and methods of this description. The memories 235 may be communicably connected to the processor device 230 (e.g., via a circuit or any other wired, wireless, or network connection) and may include computer code for executing one or more processes described herein. The memories may include non-volatile memories (e.g., read-only memory (ROM), erasable programmable read-only memories (EPROM), electrically erasable programmable read-only memories (EEPROM), etc.), and volatile memories (e.g., random-access memory (RAM)), or any other medium which can be used to carry or store desired program code in the form of machine-executable instructions or data structures and which can be accessed by a computer or other machine with a processor device. A basic input/output system (BIOS) may be stored in the non-volatile memories and can include the basic routines that help to transfer information between elements within the computer system.

A storage 245 may be operably connected to the system 200 via, for example, I/O interfaces (e.g., card, device) 250 and I/O ports 255. The storage 245 can include, but is not limited to, devices like a magnetic disk drive, a solid state drive, an optical drive, a flash memory card, a memory stick, etc. The storage 245 may also include a cloud-based server implemented using any commonly known cloud-computing platform, as described above. The storage 245 or memory 235 can store an operating system that controls and allocates resources of the system 200.

The system 200 may interact with network devices 260 via the I/O interfaces 250, or the I/O ports 255. Through the network devices 260, the system 200 may interact with a network. Through the network, the system 200 may be logically connected to remote computers. Through the network, the server-side platform 210 may communicate with the client-side platform 220, as described above. The networks with which the system 200 may interact include, but are not limited to, a local area network (LAN), a wide area network (WAN), and other networks.

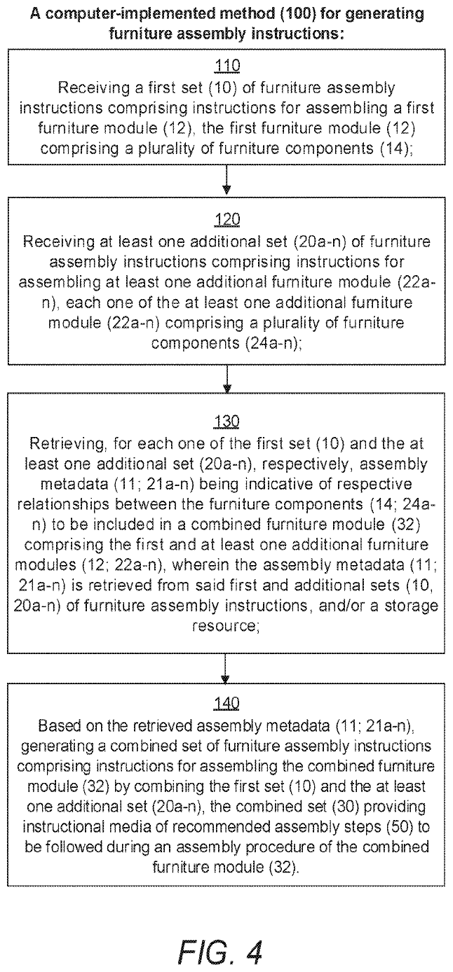

FIG. 4 shows an exemplary method 100 for generating furniture assembly instructions. The method 100 comprises receiving 110 a first set 10 of furniture assembly instructions comprising instructions for assembling a first furniture module 12, the first furniture module 12 comprising a plurality of furniture components 14. The method 100 further comprises receiving 120 at least one additional set 20a-n of furniture assembly instructions comprising instructions for assembling at least one additional furniture module 22a-n, each one of the at least one additional furniture module 22a-n comprising a plurality of furniture components 24a-n. The method 100 further comprises retrieving 130, for each one of the first set 10 and the at least one additional set 20a-n, respectively, assembly metadata 11, 21a-n being indicative of respective relationships between the furniture components 14, 24a-n to be included in a combined furniture module 32 comprising the first furniture module 12 and the at least one additional furniture module 22a-n. The method 100 further comprises, based on the retrieved assembly metadata 11, 21a-n, generating 140 the combined set 30 by combining the first and at least one additional sets 10, 20a-n, the combined set 30 providing instructional media of recommended assembly steps 50 to be followed during an assembly procedure of the combined furniture module 32.

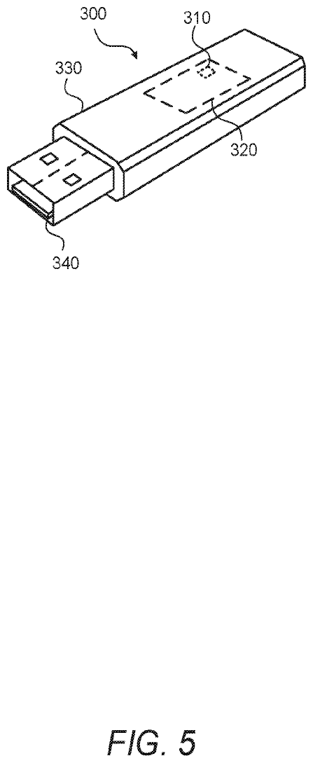

With reference to FIG. 5, a schematic illustration of a (non-transitory) computer-readable (storage) medium 300 is shown according to one exemplary embodiment. The computer-readable medium 300 may be associated with or connected to the system 200 as described herein, and is capable of storing a computer program product 310. The computer-readable medium 300 in the disclosed embodiment is a memory stick, such as a Universal Serial Bus (USB) stick. The USB stick 300 comprises a housing 330 having an interface, such as a connector 340, and a memory chip 320. In the disclosed embodiment, the memory chip 320 is a flash memory, i.e., a non-volatile data storage that can be electrically erased and re-programmed. The memory chip 320 stores the computer program product 310 which is programmed with computer program code (instructions) that when loaded into a processor device, will perform a method, for instance the method 100 explained with reference to FIG. 4. The USB stick 300 is arranged to be connected to and read by a reading device for loading the instructions into the processor device. It should be noted that a computer-readable medium can also be other mediums such as compact discs, digital video discs, hard drives or other memory technologies commonly used. The computer program code (instructions) can also be downloaded from the computer-readable medium via a wireless interface to be loaded into the processing device.

Further alternative aspects of the present disclosure are described in the following numbered clauses.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method for generating furniture assembly instructions, comprising:
receiving a first set of furniture assembly instructions comprising instructions for assembling a first furniture module, the first furniture module comprising a plurality of furniture components;
receiving at least one additional set of furniture assembly instructions comprising instructions for assembling at least one additional furniture module, each one of the at least one additional furniture module comprising a plurality of furniture components;
retrieving, for each one of the first set and the at least one additional set, respectively, assembly metadata being indicative of respective relationships between the furniture components to be included in a combined furniture module comprising the first furniture module and the at least one additional furniture module, wherein the assembly metadata is retrieved from said first and additional sets of furniture assembly instructions, and/or a storage resource; and
based on the retrieved assembly metadata, generating a combined set of furniture assembly instructions comprising instructions for assembling the combined furniture module by combining the first set and the at least one additional set, the combined set providing instructional media of recommended assembly steps (50) to be followed during an assembly procedure of the combined furniture module.

2. The computer-implemented method according to claim 1, further comprising receiving one or more assembly optimization inputs configured to cause one or more changes to the combined set of furniture assembly instructions when applied in the generation thereof, and wherein said generating of the combined set comprises determining an order of the recommended assembly steps based on the one or more assembly optimization inputs.

3. The computer-implemented method according to claim 2, wherein the order comprises:
a starting furniture component of either one of the first furniture module or the at least one additional furniture module; and
after the starting furniture component and for all remaining furniture components to be included in the combined furniture module, a plurality of subsequent furniture components of either one of the first furniture module or the at least one additional furniture module.

4. The computer-implemented method according to claim 2, wherein the order is determined by combining weighted values of a plurality of the one or more assembly optimization inputs.

5. The computer-implemented method according to claim 2, wherein the one or more assembly optimization inputs comprise environmental data of the physical environment in which the combined furniture module is to be assembled.

6. The computer-implemented method according to claim 5, wherein the environmental data is obtained by means of a near real-time 3D scanning tool and/or a room layout file.

7. The computer-implemented method according to claim 5, further comprising receiving user input through an augmented reality interface, wherein the user input defines a virtual bounding volume that is virtually placed in a 3D space representation of the physical environment where the combined furniture module is to be assembled,
wherein the virtual bounding volume is adapted to be further manipulated through the augmented reality interface based on one or more intersections in 3D space between the virtual bounding volume and 3D data corresponding to physical objects located in the physical environment,
wherein the environmental data is obtained by means of the manipulated virtual bounding volume.

8. The computer-implemented method according to claim 2, wherein the one or more assembly optimization inputs comprise furniture data of the first furniture module and the at least one additional furniture module.

9. The computer-implemented method according to claim 8, wherein the furniture data is obtained from 3D object models and/or product lists.

10. The computer-implemented method according to claim 2, wherein the one or more assembly optimization inputs comprise safety data of external restrictions affecting the assembly procedure.

11. The computer-implemented method according to claim 2, wherein the one or more assembly optimization inputs comprise assembler data of one or more persons performing the assembly procedure.

12. The computer-implemented method according to claim 1, wherein the assembly metadata comprises, for each one of the first and additional set(s), degrees of compatibility of said furniture components to be included in the combined furniture module.

13. The computer-implemented method according to claim 1, wherein the instructional media of the recommended assembly steps (50) are provided in a user-controllable interface, the user-controllable interface being a textual interface, a graphical interface, an auditory interface, and/or an augmented reality interface.

14. The computer-implemented method according to claim 13, wherein the user-controllable interface is configured to receive user instructions to selectively step through the recommended assembly steps.

15. The computer-implemented method according to claim 1, further comprising compiling the combined set of assembly instructions such that it can be provided as a physical brochure.

16. The computer-implemented method according to claim 1, wherein the retrieving of the assembly metadata is triggered by receiving a user request to combine the first set and the at least one additional set into the combined set of furniture assembly instructions.

17. The computer-implemented method according to claim 1, wherein:
said receiving of the first set of furniture assembly instructions involves scanning a first identifier being arranged on any of the plurality of furniture components of the first furniture module, on a furniture package thereof and/or on a furniture assembly manual thereof, and requesting the first set of furniture assembly instructions from a storage resource using said first identifier as a reference; and
said receiving of the at least one additional set of furniture assembly instructions involves scanning a respective second identifier being arranged on any of the plurality of furniture components of said each one of the at least one additional furniture module, on a furniture package thereof and/or on a furniture assembly manual thereof, and requesting the at least one additional set of furniture assembly instructions from a storage resource using said respective second identifier as a reference.

18. The computer-implemented method according to claim 1, further comprising:
scanning an identifier on any of the furniture components furniture modules or furniture packages thereof, and
using the identifier as a reference, requesting placement-related information of said furniture components, furniture modules, or furniture packages thereof based on the recommended assembly steps.

19. A computerized system for generating furniture assembly instructions, the system comprising one or more processor devices being configured to:
receive a first set of furniture assembly instructions comprising instructions for assembling a first furniture module, the first furniture module comprising a plurality of furniture components;
receive at least one additional set of furniture assembly instructions comprising instructions for assembling at least one additional furniture module, each one of the at least one additional furniture module comprising a plurality of furniture components;
retrieve, for each one of the first set and the at least one additional set, respectively, assembly metadata being indicative of respective relationships between the furniture components to be included in a combined furniture module comprising the first furniture module and the at least one additional furniture module wherein the assembly is retrieved from said first and additional sets of furniture assembly instructions, and/or a storage resource; and
based on the retrieved assembly metadata, generate a combined set of furniture assembly instructions comprising instructions for assembling the combined furniture module by combining the first set and the at least one additional set, the combined set providing instructional media of recommended assembly steps to be followed during an assembly procedure of the combined furniture module.

20. A non-transitory computer-readable storage medium comprising instructions, which when executed by a processor device, cause the processor device to perform the method of claim 1.
